(19) United States
(12) Patent Application Publication
(10) Pub. No.: US 2026/0015094 A1
(43) Pub. Date: Jan. 15, 2026

(54) AIRCRAFT PROPULSION SYSTEM, APPARATUS AND METHOD

(71) Applicant: GKN AEROSPACE SERVICES LIMITED, Solihull (GB)

(72) Inventors: Simon Taylor, Solihull (GB); Joseph Stonham, Solihull (GB); Elena Madrid, Solihull (GB); Stephen Harrison, Solihull (GB)

(21) Appl. No.: 18/881,730

(22) PCT Filed: Jul. 5, 2023
(86) PCT No.: PCT/GB2023/051768

§ 371 Date: Jan. 6, 2025

(30) Foreign Application Priority Data
Jul. 8, 2022 (GB) 2210065.5

(51) Int. Cl. B64D 27/355; B60L 58/30; B64D 41/00; H01M 8/04029; H01M 8/04082; H01M 8/04089

(52) U.S. Cl. CPC B64D 27/355; B60L 58/30; B64D 41/00; H01M 8/04029; H01M 8/04104; H01M 8/04201; B64D 2041/005; H01M 2250/20

(57) ABSTRACT

The present invention relates to a power unit suitable for use in an aircraft comprising: at least one fuel cell; at least two fuel sources for providing fuel to the at least one fuel cell; wherein a first fuel source is a hydrogen supply arranged to provide hydrogen to a first fuel cell of the at least one fuel cell, and wherein a second fuel source is an air gas supply arranged to provide air gas to a first fuel cell of the at least one fuel cell.

### TECHNICAL FIELD

The present invention is concerned with aircraft propulsion systems and power systems. In particular, to aircraft propulsion arrangements which are able to provide a controllably variable level of power and, therefore, thrust. Different levels of thrust may be delivered to an aircraft based on the specific stage of flight of the aircraft. This invention is also concerned with auxiliary power units (APUs) and secondary power unit (SPU) for aircraft.

Aircraft gas turbine systems typically provide in the region of 50% of their ground static propulsive power (power required to provide thrust force) at top of climb conditions but around 100% during takeoff. As such, there is a difference between the power that is to be delivered by an aircraft propulsion system during different stages of flight of an aircraft.

Typically, gas turbines operate well in this aspect as both the thrust lapse of a gas turbine engine and therefore the ratio of thrust to power of takeoff and top of climb are generally well suited to the inherent properties of a gas turbine. Further, the high specific power afforded by larger and fewer gas turbines leads to little competition from other propulsion architectures due to economic considerations. Therefore, modern systems favour the gas turbine for aircraft propulsion arrangements.

Drawbacks to gas turbine engines include environmental demands, however to date no serious alternatives to the gas turbine engine exist that are able to provide varying thrust in the same manner at similar economic considerations. As such, the gas turbine is the preferred and de facto option for use in aircraft.

Although hydrogen fuels and hydrogen synthetic fuels (synfuels) are occasionally used in aircraft, this is not regularly the case in larger aircraft and not at all in passenger aircraft. This is by virtue of the specific power that can be provided by gas turbines in comparison to that provided by hydrogen systems. Gas turbines can achieve around 5 to 8 KW/kg for a typical system, while hydrogen fuel cell systems can achieve around 1 kW/kg. As such, hydrogen is a reasonable, and an environmentally conscious, choice for smaller aircraft but all but entirely prevented from use in commercial, larger systems.

Fuel cells using hydrogen are under investigation, e.g. Proton Exchange Membrane (PEM), and recent work has indicated that the specific power value for such systems may optimistically reach 2 kW/kg in the next 5 to 10 years. Some other work has noted that there may be an absolute maximum value of around 1.8 kW/kg. As such, it appears that these systems could not be feasible for use in commercial, passenger aircraft without significant economic drawbacks.

Fuel cells can be operated in an overrated function to provide around 25% greater output for a small amount of time. This figure is higher at the start of life for fuel cells but degrades towards the end of life. Due to the mechanics of overrating, damage may be done to the fuel cell if overrated for long periods and will anyhow lead to degradation of life of the fuel cell. Even using this method, however, clearly the significant difference between takeoff thrust and top of climb thrust cannot be accounted for in a fuel cell propulsion system.

Aircraft therefore typically require around twice the power during takeoff and climb compared to cruise. This takeoff and climb phase can last around 5-20 minutes compared to the more than 1 (and up to more than 12) hours of flight time. The total duration of max power within a flight is approximately 5 to 30 mins. The duration from takeoff to cruise altitude transition is of the order of <300 s for peak power. The remaining peak power is a risk contingency for go arounds (during pre-landing phases) and deviation to another airport. The current state of the art arrangements contain such remaining peak power for around three go arounds and one deviation to another airport. For vertical takeoff aircraft, the peak power for vertical flight is around three to four times of that needed when compared to cruise. The duration of the peak power required for takeoff/landing and transition between flight modes may be of the order of around 15 to 60 s with a total time of less than 120 s but this may depend upon operational specific requirements.

To preserve hydrogen fuel typically fuel cell systems are designed to consume hydrogen and to lead to a waste of air (and therefore of oxygen) of up to 50%. Although this may benefit low quality heat dissipation because of the reaction into the air, it requires greater compression power (nearly double) and therefore increases the parasitic losses where compression is between 15-45% of the fuel cell power and the most significant parasitic power loss. Considerations regarding the cathode size of the stack takes into account the needed rate of oxygen reaction, whereby the O2 is approximately 20% of atmospheric air.

Oxygen may be used in a fuel cell however, oxygen is 16 times the mass of hydrogen and is needed in a ratio of 8:1 (for H2O). As such, carrying oxygen onboard the aircraft is not seen as effective for flight.

Therefore, there are developments that can be made in this field and advantages that can be obtained from these developments. The inventors of an invention described herein have however created an alternative propulsion arrangement which has a wide range of previously unavailable advantages as described herein.

### SUMMARY OF THE INVENTION

Aspects of the invention are set out in the accompanying claims.

Viewed from first aspect there is provided a power unit suitable for use in an aircraft comprising: at least one fuel cell; at least two fuel sources for providing fuel to the at least one fuel cell; wherein a first fuel source is a hydrogen supply arranged to provide hydrogen to a first fuel cell of the at least one fuel cell, and wherein a second fuel source is an air gas supply arranged to provide air gas to a first fuel cell of the at least one fuel cell.

The provision of hydrogen to a fuel cell alongside an air source enables a fuel cell to be operated to output high efficiency electrical power. The fuel cell does not produce emissions in the manner that a combustion engine might. In this way, the use of such a power unit provides a cleaner production of energy for use in, for example, the generation of thrust for flight. The thrust may be provided from the power output by the power unit of the first aspect.

In an example, there is provided a power unit wherein the at least one fuel cell comprises a first fuel cell and a second fuel cell, and wherein a third fuel source is an oxygen supply arranged to provide oxygen to the second fuel cell. In an example, there is provided a power unit wherein the hydrogen supply is further arranged to provide hydrogen to the second fuel cell.

This arrangement provides a second fuel cell operating on a higher percentage oxygen supply. The oxygen, acting as fuel as the oxidant, and the hydrogen, acting as a fuel as reactant, are combined in the second fuel cell to provide a high energy output fuel cell. The high energy output is assisted by the use of high purity oxygen and high purity hydrogen.

This arrangement therefore has a medium energy output fuel cell operating on high purity hydrogen and air and a high energy output fuel cell operating on high purity hydrogen and high purity oxygen, which may provide a boost or the like in power output, when operated alongside the medium energy output fuel cell. The arrangement is particularly useful in systems which have power requirements that vary significantly over time. Such is the case in systems or vehicles requiring changes in thrust over stages of travel, such as aircraft during takeoff and climb, or racecars on straight portions of track. Both fuel cells also have emission-based advantages over convention combustion engines.

In an example, there is provided a power unit wherein the air gas supply is further arranged to provide fluid communication for the air gas between the air gas supply and the second fuel cell. In an example, there is provided a power unit wherein the oxygen supply is further arranged to provide oxygen to the first fuel cell.

This arrangement provides a selective powering function to the first fuel cell. By controlling the ratio of high purity oxygen and air, used for the fuel in the first fuel cell, the operator can have greater control over the power provided from the power unit. In this way, the user has a more flexible arrangement for the provision of power from the power unit, and therefore can tailor this to the circumstances in which he or she finds themselves. For example, maximum power output could be provided from a high purity oxygen being provided to both fuel cells, while a standard power output could be provided from air and hydrogen being provided to the first fuel cell. In this way, the user has additional control over the “boost” function of the fuel cells within the power unit.

In an example, there is provided a power unit wherein the system further comprises: at least one compressor for compressing a fuel source of the at least two fuel sources, wherein a first compressor of the at least one compressor and a fuel source of the at least two fuel sources are arranged so that the fuel from the fuel source is communicated to the compressor prior to being provided to a fuel cell of the at least one fuel cell.

Compression of the fuels provided to the fuel cell can increase the power output of the fuel cell. Once again, by compressing a fuel source, a greater amount of e.g. hydrogen or oxygen can be provided to the fuel cell, therefore the user has an increased level of control over the electrical output of the fuel cell. In conjunction with the above advantages, this arrangement provides a significant improvement in the level of control the user has over the power output from the power unit.

In an example, there is provided a power unit, wherein the oxygen supply is arranged in fluid communication with a second compressor of the at least one compressor, the oxygen supply arranged to: provide oxygen to the second fuel cell; provide oxygen to the second compressor; and, provide oxygen to the first fuel cell. In an example, there is provided a power unit wherein the oxygen supply is arranged to provide uncompressed oxygen to the second fuel cell and compressed oxygen to the first fuel cell.

This arrangement provides a large range of combinations of compression and provision of oxygen to fuel cells for use as desired by the user. Again, each of these steps increases the users overall control of the output of the power unit. In this way, the power unit can be used to provide power most suitable for the requirements at the time. As mentioned above, this works particularly well in a transportation and vehicle setting.

Such controllable power output renders fuel cells very attractive for use in technology fields that are dominated by combustion engines. In this way, the previous drawbacks of using fuel cells are overcome and this in turn reduces the environmental impact of the provision of power in vehicles as conventional fuels can be replaced with environmentally friendly fuels without impact on performance.

In an example, there is provided a power unit comprising a control unit to control supply of fuel from the at least two fuel sources to the at least one fuel cell, wherein the second fuel cell can be selectively activated by selectively providing fuel to the second fuel cell.

This arrangement provides greater control for the user when operating the power unit.

In an example, there is provided a power unit wherein the first fuel cell and second fuel cell are arranged to use a common balance of plant.

This arrangement provides a power unit using the same balance of plant for two fuel cells. Balance of plant refers to the support components and auxiliary systems of a power unit needed to deliver the energy from the power unit. Therefore, in a power unit of one fuel cell, there are a set number of components needed for the unit to function. The inclusion of a second fuel cell is most efficient, both from a weight and electrical point of view, when the same infrastructure can be used for the second fuel cell. In examples, the second fuel cell may require some small additional components, so either the same balance of plant can be used or only minor additional balance of plant is required for the second fuel cell. This renders the power unit particularly effective at the provision of a “boost” fuel cell at a very reduced weight cost for the system.

In an example, there is provided a power unit comprising a liquid heat exchanger arrangement for exchanging heat with the at least one fuel cell, the liquid heat exchanger comprising a fluid arranged at least at one point in the liquid heat exchanger arrangement in thermal communication with the at least one fuel cell, and a cryogenic heat exchanger arrangement arranged at least at one point in thermal communication with the fluid.

This arrangement provides highly efficient heat exchange functions to various components in the system. The liquid in the heat exchanger can be maintained at very low temperatures due to the presence of the cryogenic heat exchanger and thereby increase electrical efficiency of the fuel cell by the cold fluid in the liquid heat exchanger.

In an example, there is provided a power unit wherein the third fuel source is a liquid oxygen supply and the third fuel source is arranged to provide oxygen to the cryogenic heat exchanger arrangement.

This arrangement provides highly efficient heat exchange functions to various components in the system. In particular, in a system where cryogenic oxygen is present, the use of cryogenic oxygen in thermal energy exchange provides a high electrical efficiency from the highly improved cooling of the components.

In an example, there is provided a power unit wherein the third fuel source is arranged to: provide liquid oxygen to the cryogenic heat exchanger arrangement to cool the fluid, and provide gaseous oxygen from the cryogenic heat exchanger arrangement to the at least one fuel cell.

This arrangement provides highly efficient heat exchange functions to various components in the system. In particular, in a system where cryogenic oxygen is present and used in electrical power generation, the use of cryogenic oxygen in thermal energy exchange prior to introduction into the fuel cell provides a synergistic effect of high electrical efficiency stemming from both the cooling of the components and the improved performance of the fuel cell.

In an example, there is provided a power unit wherein the liquid heat exchanger arrangement comprises a fluid conduit through which fluid can flow and a liquid heat exchanger and wherein the cryogenic heat exchanger arrangement comprises a cryogen conduit through which cryogen can flow and a cryogenic heat exchanger.

Such an arrangement provides careful and controllable delivery of the fluid for cooling and the cryogen for cooling and subsequently delivery into the fuel cell.

In an example, there is provided a power unit, wherein the air gas supply is environmental control system exhaust gas or ambient air.

By using the environmental control system exhaust gas a higher percentage of oxygen can be provided to the fuel cell than by using air. Ambient air may be compressed to provide a similarly higher percentage oxygen fuel to the fuel cell. This provision may be controllable to allow for a temporary increase in the electrical output of the fuel cell during required periods. Such temporary increase in electrical output may be referred to as a boost period.

In an example, there is provided a power unit wherein the hydrogen supply is a hydrogen gas supply to provide hydrogen gas arranged to provide hydrogen gas to a first fuel cell of the at least one fuel cell. The hydrogen can be provided as a compressed gas, can be held as a liquid in the store and then used in heat exchange processes to evaporate before being provided to the fuel cell as gaseous hydrogen. This gaseous hydrogen may still be of a relatively low temperature when provided to the fuel cell or of a temperature that best fits efficiencies for the scenario and fuel cell in use.

Viewed from another aspect there is provided a power unit comprising: at least two fuel cell stacks; at least two fuel sources for providing fuel to the two fuel cells; wherein a first fuel source is a hydrogen gas supply arranged to provide hydrogen gas to each of the two fuel cells; and, wherein a second fuel source is an air gas supply arranged to provide air gas to each of the two fuel cells.

Viewed from yet another aspect there is provided an aircraft propulsion system comprising the power unit of any earlier aspect or example.

Use of this power unit in an aircraft propulsion system is particularly beneficial as the controllable power output accounts extremely well for the difference in power required between the takeoff and climb and cruise phases of flight. Furthermore, the environmental advantages of using clean fuels over combustion fuel reduces the environmental cost of a popular, and ever increasing in use, method of transport.

Viewed from a further aspect there is provided a method of providing variable power for use in an aircraft comprising: providing a first fuel from a first fuel source to a first fuel cell, wherein the first fuel source is a hydrogen gas supply to provide hydrogen gas to the first fuel cell; providing a second fuel from a second fuel source to a first fuel cell, wherein the second fuel source is an air gas supply to provide air gas to the first fuel cell; activating the first fuel cell to provide power using the hydrogen gas and the air gas; providing hydrogen gas from the hydrogen supply to a second fuel cell; providing a third fuel from a third fuel source to the second fuel cell, wherein the third fuel source is an oxygen supply to provide oxygen to the second fuel cell; selectively activating the second fuel cell to provide additional power.

As mentioned above provision of a variable power for use in an aircraft is particularly beneficial as the controllable (variable) power output accounts extremely well for the difference in power required between the takeoff and climb and cruise phases of flight. Furthermore, there are environmental benefits as mentioned above.

In an example, there is provided a method, wherein the second fuel cell is selectively activated during takeoff and climb phases of an aircraft flight.

### BRIEF DESCRIPTION OF THE DRAWINGS

One or more embodiments of the invention will now be described, by way of example only, and with reference to the following figures in which:

FIG. 1 shows a schematic of a fuel cell propulsion system according to an example of the present invention;

FIG. 2 shows a schematic of a fuel cell propulsion system according to an example of the present invention;

FIG. 3 shows a schematic of a fuel cell propulsion system according to an example of the present invention;

FIG. 4 shows a schematic of a fuel cell propulsion system according to an example of the present invention;

FIG. 5 shows a schematic of a fuel cell propulsion system according to an example of the present invention; and

FIG. 6 shows a schematic of a fuel cell propulsion system according to an example of the present invention; and

FIG. 7 shows a schematic of a fuel cell propulsion system according to an example of the present invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

An invention described herein relates to generating propulsion for an aircraft and power systems. A particular engine system for an aircraft involves multiple fuel cells. The generation of propulsion is controllably variable so as to provide additional power during stages of flight that require additional power. Additional power may be provided during takeoff/climb and then not be provided during cruising. An invention described herein relates to power generation through an Auxiliary Power Unit (APU), which can be designed so as to provide a number of necessary functions for an aircraft. The APU may be small and provide only aircraft electrical power (typically secondary or emergency) or be sized larger so as to, alternatively or additionally, provide propulsion.

The present invention provides a number of inventive strategies that enable oxygen to be used more efficiently in fuel cell propulsion systems, or enable use of enriched oxygen within a fuel cell propulsion system. Fuel cells operate by being provided with some portion of hydrogen and some portion of oxygen (e.g. from air) as reactant and oxidant respectively. Fuel cells use these to provide electrical energy. Herein, these are generally referred to as “fuels” provided to fuel cells, i.e. the hydrogen and oxygen are referred to as “fuels”. The term “fuel” as used in the first sense is as reactant, and in the second sense as oxidant. The term is used in general to broadly refer to a matter that is in some way changed in a process that may produce useable energy, such as the conversion of hydrogen and oxygen into water at the release of electrical energy.

Oxygen sources that may provide oxygen for use in a fuel cell propulsion system, for example in an aircraft arrangement, include the environment control system (ECS), obtaining oxygen (O2) via enrichment of ambient air or use of a dedicated (or otherwise) oxygen source. The oxygen source may be a liquid oxygen source (LOx). Advantageously the liquid oxygen is less space intensive than oxygen in a gaseous phase, therefore there are capacity advantages associated with use of LOX in any of the systems described herein. Specifically the volumetric density of LOX is superior to oxygen in gaseous form. Aircraft often carry on-board oxygen and this is a byproduct of the electrolysis process in the production of hydrogen (H2) from water. Many current aircraft carry on-board oxygen in bottles that can be used in case of cabin depressurisation as might occur from a blown out window or the like. The amount stored is suitable to cover the period until a descent to a safe altitude can be achieved. While passengers use drop down oxygen masks, the crew for example may use portable oxygen bottles. As such, current aircraft often have an oxygen generator or, more commonly, gaseous oxygen tanks onboard.

Additional power may be provided from a fuel cell arrangement through the use of a control regime wherein oxygen (O2) is utilized and H2 is spent during the process (this H2 may be recirculated back into the system and therefore re-used). An advantage available from this arrangement is related to the benefits in lower mass of H2 being 1/16 of the mass of O2, while being factor ⅛ in the reaction to H2O. The volume and mass of H2 is such that a small increase in mass and volume will be comparatively small in the design. Recirculation of H2 is also easier to achieve and beneficial as there is no requirement to deal with oxygen depleted air. A further advantage is that energy is not wasted on compression if the air is released from the aircraft (spilled overboard). Using oxygen and hydrogen, the only waste product from the fuel cell is water, rather than nitrogen etc. that arise from use of air.

Other methods for controllably providing additional power are shown in the following Figures.

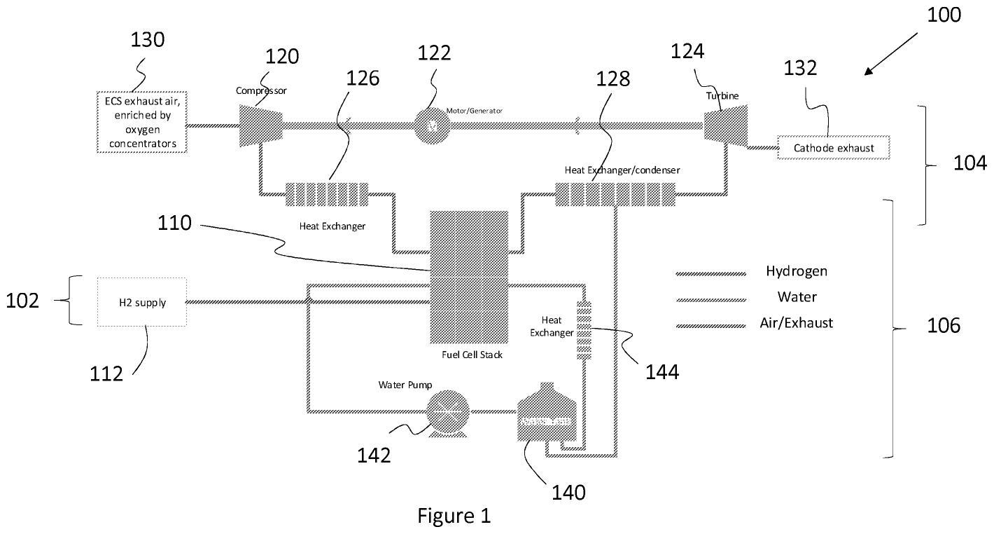

Referring now to FIG. 1, there is shown a propulsion system 100 comprising a fuel cell stack 110. The fuel cell stack 110 is connected to a H2 supply 112 via a H2 supply line. This hydrogen portion is labelled by portion 102.

While a hydrogen supply will be used throughout the examples shown herein, alternative suitable fuels such as reformed hydrocarbons, or the like, could be used with the proposed propulsion system. The hydrogen supply may comprise 100% hydrogen or a lower percentage. Common hydrogen source may have small impurities, such as Carbon Monoxide (CO), Carbon Dioxide (CO2) Nitrogen Dioxide (N2) Hydrogen Sulfide (H2S), however a purity of hydrogen of around 99.99% or higher is preferable.

The propulsion system 100 has a compressor 120, a motor/generator 122 and a turbine 124. The compressor 120 is connected to a heat exchanger 126 and the turbine 124 is connected to another heat exchanger/condenser 128. The Compressor 120 is connected to the ECS exhaust air supply 130. The ECS exhaust air supply 130 may be enriched by oxygen concentrators. This enrichment may happen before or after the oxygen reaches the air supply 130 in the process. The turbine 124 is connected to the cathode exhaust 132. This air/exhaust portion is labelled by portion 104. Element 130 is referred to as an ECS exhaust air supply but may also be an external (ambient) air supply or the like. The main function of element 130 is to provide air (whether oxygen enriched in some way or not) for use in the fuel cell stack 110.

The two heat exchangers 126, 128 are connected to the fuel cell stack 110. Heat exchanger 126 is connected to compressor 120 and fuel cell stack 110 and cools air exiting from the compressor 120. This heat exchanger 126 may be optional depending on both the temperature limits of the fuel cell stack 110 and the temperature of the air after compression by the compressor 120. The fuel cell stack 110 is connected to a water tank 140 via a water pump 142 and a heat exchanger 144. The water tank 140 is connected to the heat exchanger/condenser 128. This water portion is labelled by portion 106.

The examples shown herein are of a water cooled fuel cell stack system. The examples shown have been simplified to emphasise the most inventive elements of the present system. However, these are merely examples. Such examples may omit in-depth details relating to less prevalent elements in the system, such as optional recirculation systems that might be used to recirculate hydrogen. Other omissions include humidifiers that can be used on the cathode air supply. Therefore, while not explicitly shown, such features can be included in the present arrangement. Furthermore, the present arrangements may be used with evaporative cooled fuel cell stacks.

Indeed, the condensing heat exchanger 128 may be optional for the high power phase with no condense water extracted. Instead, the moist air may be sent overboard (“spilled”) or stored in an intermediate container until it can be sent overboard. In this manner, the pressure loss inherent in the use of the condense heat exchanger 128 would not be included in the arrangement, which leads to a higher performance system (in the form of more power). To compensate for this spilling overboard of moist air, a slightly larger water tank may be used.

In the arrangement shown in FIG. 1, the propulsion system 100 uses ECS air with oxygen concentrators. There are a number of advantages that stem from this arrangement:

The oxygen concentrators (oxygen separators) may be used to produce a higher percentage of O2 in the air in the portion 104 than in the cabin or than in external ambient air. Use of a higher percentage of O2 for a period will enable the fuel cell to operate at a net higher power level during that period. In contrast, systems without an oxygen concentrator use oxygen as contained in ambient air. The result is that many current fuel cell systems waste air and consume H2 to its fullest extent. This is necessary with ambient air as the approximately 21% O2 (as in air) will become depleted and could potentially starve the fuel cell. This is not the case with an oxygen system. O2 in the reactant ratio is 4 times heavier than the H2 and, as such it makes more sense that, if waste is to occur, the H2 is wasted. This is further justified as substantially more H2 is stored than O2 and, as such, the change in mass at system level (tank mass specifically) is lower. Additionally, and beneficially, in the high power case for a cryogenically cooled system this arrangement allows for more available heat dissipation in the liquid hydrogen.

The air source requires less compression than an external ambient air (which, at altitude, can be low). Our estimates show that the compression is around 3 times rather than 9 times which would be required for ambient air. This is because the air source may come from the cabin air, which has already been pressurised, and because the air can be enriched with oxygen. Enrichment with oxygen results in less air being required, and accordingly less compression is required.

Additional advantages can be gained from the lower temperature air in the air source when compared to compressed ambient air. In the arrangement wherein heat exchanger 126 is omitted, there is no pressure loss associated with the inclusion of the heat exchanger 126. Accordingly, the lower air temperature on the cathode side means that the fuel cell stack 110 is able to dissipate more heat into the air before an equivalent stack temperature is reached (equivalent temperature to an arrangement including heat exchanger 126). In this way, the omission of the heat exchanger 126 may be beneficial as enabling operation of the fuel cell stack 110 at a higher power.

The oxygen concentrators can be used so as to increase the O2 ratio within the air supplied in the portion 104 or the oxygen concentrators may be used to supply pure oxygen to the system 100. As previously mentioned, use of higher proportion of O2 in the air supply 130 to the fuel cell stack 110 enables a greater power output from the fuel cell stack 110 as there is less non-reactive air (nitrogen etc) passing through the fuel cell stack 110. Alternatively, a smaller fuel cell stack can be provided which provides the same output power (as a result of the greater per size power output of the present fuel cell stack 110 arrangement).

In the event that liquid oxygen is used from an oxygen supply (such as a tank or the like), the specific heat of vaporization and specific heat capacity of the oxygen can be used to cool elements of the propulsion system 100. Cooling of electrical elements leads to gains in efficiencies die to lack of e.g. eddy currents etc. Furthermore, use of pure oxygen in the system 100 can enable use of a smaller fuel cell area and therefore smaller and lighter stack 110. This leads to efficiency benefits as a result of the mass of the stack that needs to be carried, for example, by an aircraft in use. The lower mass the stack, the less fuel required to account for that mass in comparison to a heavier system.

Liquid oxygen enables an even lower inlet temperature of the oxidant which in turn enables the fuel cell stack 110 to operate at potentially higher heat dissipation and therefore power. Further advantages include that, as the only gas content is oxygen, this oxygen could be consumed entirely. For an air system typically only 50% of the oxygen may be consumed as the system has to ensure that the fuel cell stack has sufficient O2, as such, an overprovision of O2 is preferred.

In the example shown in FIG. 1, the fuel cell stack 110 needs to operate well in both the above-described cases as such a more primary advantage relates to increased stack power (prior to accounting for parasitic losses, ie turbocompressor, pumps etc.) and net power, rather than a slightly more secondary advantage regarding resizing the stack 110.

By re-using the ECS air via the supply 130, the system 100 has no requirement for an external air intake to bring in air from the surrounding environment. As such, there are aerodynamic drag benefits associated with the omission of an external air intake element. This drag benefit translates to a benefit associated with the energy demand on the system 100 as a whole; it can be understood that the system 100 would need to provide more thrust to accommodate an element that was likely to provide additional drag. By removing the need for this element, the system 100 is more efficient.

Alternatively, the intake may be included and be of a size and shape that is of a fixed geometry. The intake may be bigger for takeoff and climb and smaller for cruise. This may have the effect that the intake spills flow during cruise or the excess is consumed by the system and vented overboard. This may use more energy during cruise and is a heavier, i.e. more mass, solution than no intake. A further alternative is that the intake has a variable geometry which changes in size between different phases of flight. This solution is however a more technically complex and typically heavier than a fixed area intake.

In the present system, use of the fixed inlet is beneficial as there are not the undesirable losses in performance between takeoff and cruise as there might be in other systems.

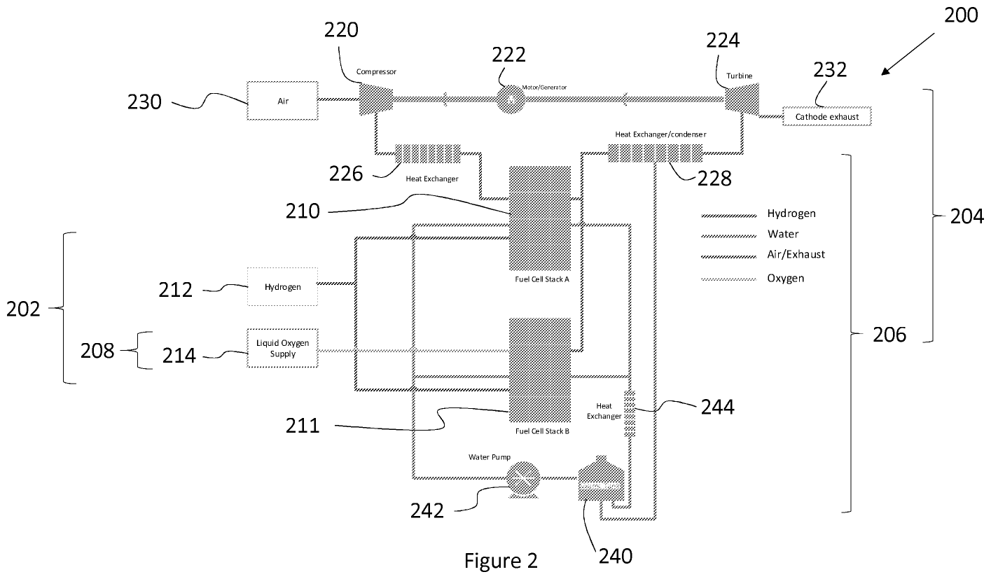

Referring to FIG. 2, there is a shown a propulsion system 200. The system 200 shown in FIG. 2 shares a number of elements with the system 100 in FIG. 1. Where the same, or a similar, element is shown in FIG. 2, the numeral from FIG. 1 will be used with the number increased by 100. So, for example, the system 100 of FIG. 1, is similar to the system 200 from FIG. 2. For conciseness, not all elements will be discussed, those that are the same may be omitted from discussion.

The fuel cell stack arrangement differs between FIG. 1 and FIG. 2. The fuel cell stack 110 in system 100 of FIG. 1 is a central, singular stack of the system 100 (though there need not only be one fuel cell stack in the arrangement of FIG. 1). In the system 200 of FIG. 2, there are two fuel cell stacks 210, 211. Fuel cell stack A 210 is arranged, in the system 200, towards the compressor 220, motor/generator 222 and turbine 224 of the air/exhaust portion 204. Fuel cell stack B is arranged towards the water tank 240, water pump 242 and the heat exchanger 244 of the water portion 206. While not explicitly shown, the system may include a regulating element such as a controller or the like, which regulates the water and hydrogen being supplied from the supplies to the two fuel cell stacks 210, 211 shown. The regulation will occur according to the power and cooling requirements of each stack 210, 211. This regulation may include feedback sensors or detectors for reading properties of the fuel cell stacks 210, 211.

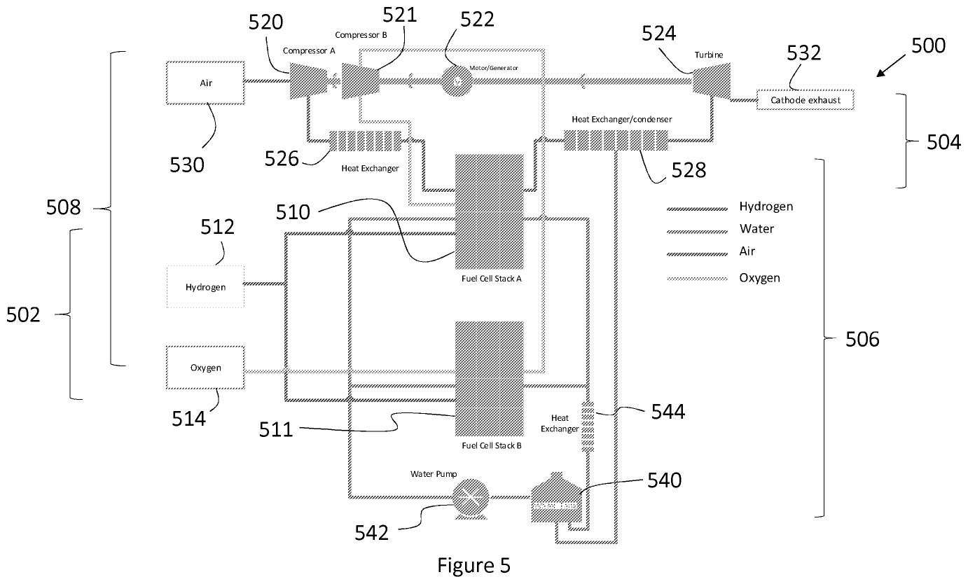

The ECS exhaust air supply 130 of FIG. 1 has been changed to an air supply 230 in the system 200 of FIG. 2. The system 200 of FIG. 2 does not need to utilise the ECS exhaust gas of the system 100 of FIG. 1, however it may do. The advantages for using ECS air have been previously mentioned and include a lack of need of compression (as the ECS air has already been compressed somewhat) and a higher O2 content. The air supply 230 is connected to a compressor 220, which is connected to both a heater exchanger 226 and a motor/generator 222. The heat exchanger 226 is connected to fuel cell stack A 210. The motor/generator 222 is connected to a turbine 224 which is connected to both a cathode exhaust 232 and a heat exchanger/condenser 228. This heat exchanger/condenser 228 is connected to both fuel cell stack A 210 and fuel cell stack B 211. These elements are part of the air/exhaust portion 204 of the system 200. In a variant of the example shown in FIG. 2 however, the second air exhaust line, which connects heat exchanger/condenser 228 to the fuel cell stack B 211 could be removed. In this arrangement, we have advantages relating to the oxygen stack which will be explained in more detail below, with reference to FIG. 5.

The water portion 206 is connected to both the fuel cell stacks 210, 211. The water portion 206 has a water tank 240, a water pump 242 and a heat exchanger 244. The water portion 206 may remove water created during operation of the fuel cell as well as provide water back to the fuel cell for cooling. For a system where the water loop is only used for cooling, another cooling medium e.g. oil, or a cryogen may be used.

The heat exchanger 244, while shown in FIG. 2 as a single heat exchanger, could be two or more heat exchangers for use in the arrangement. In a variant of FIG. 2, each fuel cell stack 210, 211 has a heat exchanger. Individual heat exchangers per fuel cell may be advantageous as the fuel cells may have vapour at different temperatures and quantities. As such, an exchanger designed for a specific fuel cell, and the properties of that fuel cell, may be more effective than an exchanger designed to be a compromise between idealised conditions for a number of different fuel cells. In another variant of FIG. 2, there is an additional heat exchanger to precool the vapour from fuel cell stack A 210 before the vapour enters heat exchanger 244.

In another variant of FIG. 2, rather than using a heat exchanger, the water is collected or vented overboard from at least fuel cell stack A 210 (and possibly also fuel cell stack B 211) during a high power operating mode. An advantage associated with collecting or venting the water is that no cooling is required, as this cooling would most likely use an air intake that would need to be included an any aircraft design for use with this arrangement and therefore increase the drag of the aircraft design. Venting overboard leads to additional considerations such as when to vent, and therefore it may be useful to collect the water in a tank prior to venting. Advantageously this allows user control over when and where the water is vented overboard. Use of a tank allows the user to avoid spilling water onto the runway, taxiway or airport-gate areas etc. This control can allow the avoidance of spraying water over residential areas, which may be located below a flight path.

This is more easily achievable in system 200 as fuel cell stack B 211 does not need to be connected to heat exchanger 244. For all arrangements shown herein systems 200, 300, 400, 500 and 600 (shown in FIGS. 2 to 6) the heat exchanger 244 could be sized for the cruise case only (i.e. wherein only one of the fuel cell stacks—typically fuel cell stack A 210—needs to operate) and water spent overboard during double power conditions (wherein both fuel cell stacks are operated, or a special overrated arrangement is provided).

Preferably, the water level in the system is kept roughly steady throughout usage. Therefore, if water is removed from the system, as is the case in one of the above examples, water generated by the use of the fuel cell stacks 210, 211 may be introduced to the system so that the water level is kept roughly steady throughout. The amount of water needed in the system can be calculated so that, by minimising the amount of water necessary to allow full functioning of the system, the mass of that water is optimal resulting in efficiencies from not carrying unnecessary mass.

There is a hydrogen supply 212 which is connected to both fuel cell stacks 210, 211. The hydrogen supply 212 is part of the hydrogen portion 202. Hydrogen is supplied to both fuel cell stacks 210, 211 for use in the fuel cell reaction.

Additionally in system 200, there is an oxygen supply 214 that is connected to fuel cell stack B 211. The oxygen in the oxygen supply 214 may advantageously be liquid oxygen. Use of liquid oxygen has advantages as noted earlier in terms of the volumetric density. Additional benefits from use of this arrangement may be that the fuel cell stack B 211 can be used as a vaporizer to help raise the temperature of the oxygen for input into the fuel cell stack B 211. Additionally, the oxygen can be used to cool the coolant (in FIG. 2, from the water arrangement) prior to entry into the fuel cell stacks. In this way, the coolant is more effective at its function of heat removal.

In an example, the liquid oxygen may be warmed before being input into the fuel cell stack B 211. The thermal energy for warming the liquid oxygen in the oxygen supply 214 may be taken from the fluid that dissipates the heat from fuel cell stack A 210 or fuel cell stack B 211 (or both fuel cell stacks). In the example of FIG. 2, the fluid dissipating heat from the fuel cell stacks is the water flowing in the water portion 206 comprising water tank 240, pump 242 and heat exchanger 244. The paths of the water portion 206 and the oxygen portion 208 overlap and therefore heat exchange can occur. The paths can be arranged to overlap more than is shown in the example of FIG. 2 so as to provide more effective heat exchange. In a specific example, the liquid oxygen may be warmed to 325 Kelvin before being injected into the stacks. This may provide a significant improvement over only typical heat exchangers and may be used in tandem with or in place of typical heat exchangers. The improvement has shown to be in the region of 12% heat transfer compared to traditional heat exchangers.

A dedicated heat exchanger may be introduced into the arrangements disclosed herein using liquid oxygen as a source for removal of thermal energy. Such a heat exchanger may be referred to as a “cryogenic heat exchanger” wherein, in an example, incoming warm liquid coolant is pre-cooled by the outgoing cryogenic liquid oxygen (LOx).

The LOx may be stored around 90 Kelvin or the like and be arranged to absorb sufficient thermal energy to be of a temperature of around 325 Kelvin. The flow of the LOx into the cryogenic heat exchanger dissipates more heat from the fuel cell stack and can also variate the stoichiometry of oxygen (O2) in the air inlet, thereby further improving the stack performance.

The arrangements disclosed herein may be used in aerospace applications such as in an aircraft and therefore may be used at high altitudes. The constant loss of power due to the decrease in air density (specifically O2) can be a problem in efficient fuel cell usage. The injection of higher concentration O2 air into the cathode can alleviate such problems. In a specific example, the enrichment of the O2 concentration in the inlet air is an effective method for increasing the overall efficiency of the fuel cell stack. The present arrangement of a cryogenic heat exchanger provides a great overall improvement for fuel cell performance by providing both highly efficient heat dissipation and, synergistically, improved fuel cell O2 concentration. Both contribute to highly improved electrical efficiency provided by the present cryogenic heat exchanger. This arrangement may also be used in high-temperature fuel cells.

The oxygen is delivered via the oxygen portion 208 of the system 200. The oxygen delivery to fuel cell stack B 211 enables fuel cell stack B 211 to operate at a higher power output than when using only ambient air or the like, which has a lower percentage of oxygen. The oxygen supply 214 therefore provides additional oxidant to the fuel cell stack B 211 to provide additional power. The oxygen supplied to fuel cell stack B 211 can be supplied at a lower temperature than air. This leads to fuel cell stack B 211 requiring less cooling to achieve the same power. In turn, this leads to a mass saving as less balance of plant (BoP) is required to achieve an equivalent power as for fuel cell stack A 210. As such, in this arrangement, the system 200 has one standard operating fuel cell stack A 210 and one higher power output operating fuel cell stack B 211.

The system 200 advantageously therefore can be used in two main modes. In the first mode, both fuel cell stacks 210, 211 are operating and the system 200 is providing a large amount of power. In a second mode, the fuel cell stack A 210 is operated while the fuel cell stack B 211 is not operated. This second mode provides a lower amount of power than the first mode of operation. As such, this system 200 provides an arrangement for a fuel cell propulsion system that can controllably provide different levels of power, which may be chosen by an operator or by a controller based on environmental conditions. The system 200 therefore is well suited for use in a mode of transport that may require additional power during different portions of travel, such as an aircraft, which requires additional power during takeoff and does not require this power during cruise.

There are weight considerations when providing a second fuel cell stack to the system 100 of FIG. 1. If the weight of the second fuel cell stack is too great, this will lead to an inefficient system 200 as the first fuel cell stack 210 will need to provide more power during transport to account for the weight of the second fuel cell stack 211. As such, the system 200 may be arranged to carry just enough liquid oxygen for around 6 minutes of additional power (provided by fuel cell stack B 211) during takeoff and climb. In this way, once in cruise, the first fuel cell stack A 210 is carrying the least amount of additional weight, i.e. only that which is required, thereby ensuring the system 200 is as light as possible. This arrangement, fuel cell stack A 210 with only the required fuel and fuel cell stack B 211 without any fuel, is still lighter than two conventional fuel cell systems. As such, the system 200 is particularly efficient in such an arrangement.

The sizes of the fuel cell stacks 210, 211 may not be the same. The stacks can be load balanced so as to best provide power for the specific usage of the system 200. For example, if the system 200 is used in an aircraft, the higher operating power fuel cell stack B 211 may be 50-60% smaller than the fuel cell stack A 210. In this way, the system 200 can be arranged to have minimal impact in terms of space required to house the system 200.

The additional fuel cell stack 211 would therefore not require additional balance of plant, or at least limited additional balance of plant, which, in turn, increases the specific power output. As the stack 110 is around 50-60% mass of the system 100 this could lead to around a >100% increase in total specific power of system 200 (e.g. for a 1.5 kW/kg base system, approx. 3.1-4.1 kW/kg).

A benefit of having the second fuel cell stack 211 associated exclusively with the oxygen source (i.e. using pure oxygen or very high oxygen percentage air) enables the balance of plant to be kept to a minimum for this stack integration. The fuel cell stack 211 will be sufficiently more power dense (approx. 20% cathode volume by oxidant volume for air can become 100%) compared to the baseline case.

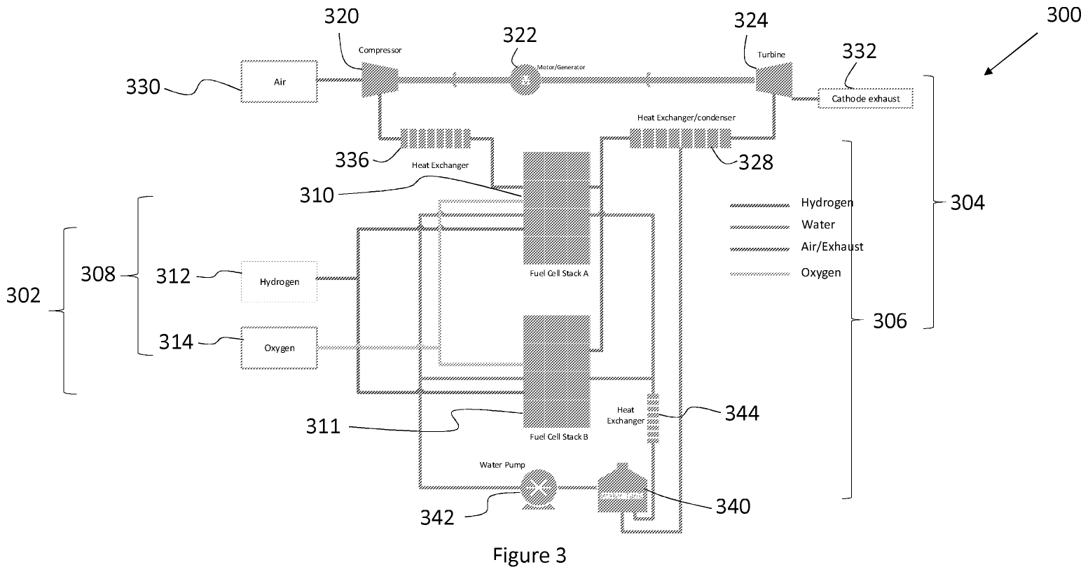

Referring to FIG. 3, there is shown a propulsion system 300. The system 300 shown in FIG. 3 shares a number of elements with the system 200 in FIG. 2. Where the same, or a similar, element is shown in FIG. 3, the numeral from FIG. 2 will be used with the number increased by 100. So, for example, the system 200 of FIG. 2, is similar to the system 300 from FIG. 3. For conciseness, not all elements will be discussed, those that are the same may be omitted from discussion.

The system 300 of FIG. 3, in comparison to the system 200 shown in FIG. 2, has an additional oxygen line from the oxygen source 314 to the first fuel cell stack A 310. Therefore, the oxygen source 314 may provide oxygen to both fuel cell stacks 310, 311. The oxygen source can provide cooled oxygen, e.g. from a liquid oxygen source, which is expanded into both stacks 310, 311. As such, the advantages of cooling, as mentioned above, can be provided to both stacks, enabling more efficient operation by the stacks 310, 311.

As the percentage of oxygen to the first fuel cell stack A 310 is increased by the provision of additional oxygen, the first fuel cell stack A 310 operates at a high power. Therefore, this is a solution to obtaining a higher net power output from the first fuel cell stack A 310 rather than requiring the use of a turbo compressor to provide additional oxygen. By omitting a turbo compressor, the mass of an aircraft propulsion system 300 can be reduced thereby reducing the amount of fuel required to operate and fly the system 300. As such, efficiencies are available by using the arrangement shown in FIG. 3. In this way, fuel cell stack A 310 can be arranged to work with air from air source 330 and/or with oxygen from the oxygen source 314. In this case specific energy increases of >100% are expected as a, e.g. for a 1.5 kW/kg base system specific powers of between 3.5-4.7 kW/kg.

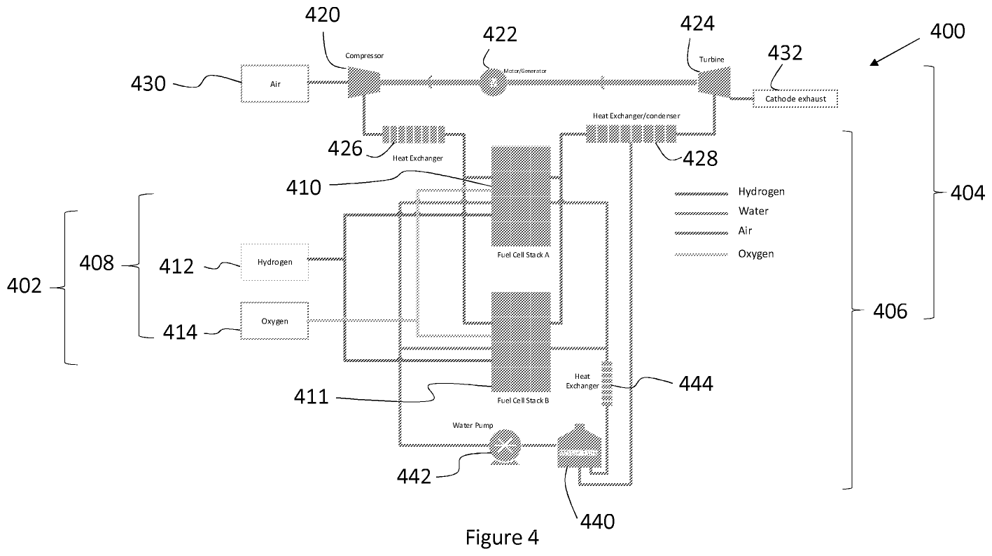

Referring to FIG. 4, there is a shown a propulsion system 400. The system 400 shown in FIG. 4 shares a number of elements with the system 300 in FIG. 3. Where the same, or a similar, element is shown in FIG. 4, the numeral from FIG. 3 will be used with the number increased by 100. So, for example, the system 300 of FIG. 3, is similar to the system 400 from FIG. 4. For conciseness, not all elements will be discussed, those that are the same may be omitted from discussion.

The heat exchanger 426 of the air portion 404 is connected to both the fuel cell stacks 410, 411. Furthermore, the oxygen supply 414 of the oxygen portion 408 is connected to both the fuel cell stacks 410, 411.

The preferred incarnation is that at least fuel cell stack A 410 is designed for operation with either air from the air supply 430 and/or oxygen from the oxygen supply 414. In this way, a turbo-compressor is not necessarily required during this high power operation (as mentioned above), therefore saving around 15-25% parasitic loss. In this case specific energy increases of >100% are expected as a, e.g. for a 1.5 kW/kg base system specific powers of between 3.0-4.3 kW/kg. This is a preferred incarnation of the system 400 from an-availability and lifetime perspective as redundancy between the fuel cell stacks can be provided in this arrangement.

In an alternate arrangement of FIG. 4, there is either one turbo compressor with increased capacity or two turbo compressors to assist aircraft which operate at 2 times power for takeoff and climb and, accordingly, 1 times power for cruise at altitude. In the event that oxygen is used there can be two benefits:
(1) there is less wastage of O2 as part of air or the associated pressure loss, and a
(2) there is no need for compression when O2 is used.

As such the turbo compressor may be a single turbo-compressor system optimized for altitude only, or two turbo compressors.

Either of the first fuel cell stack 410 and the second fuel cell stack 411 may be arranged to operate with either air from the air supply 430 or with oxygen from the oxygen supply 414. There are different advantages associated with each of these approaches.

A benefit of having two fuel cells that are built to near identical specifications, and that can both operate on air, is that the overall development cost including lifetime cost (due to maintenance repair and overhaul) will be reduced. The fuel cell stack lives are approximately 3000 to 20000 hours. If used in an aircraft, the aircraft life may be of the region of 90k-180k hours. As such, a significant number of stack changes (refurbishments or new parts) are required. If two identical stacks are used then these could be used alternately and provide a further function of redundancy, in the event of a failure of one stack in operation or the like. Due to the short operation of the second stack then the time between overhaul could be nearly doubled if the stacks are used alternatively. Such an approach requires doubling the water and air piping including valving to select the configuration. Further prognostic performance would enable stacks to be used preferentially until both are aged and need replacement. This activation of the fuel cell stacks could be done selectively through a valve system and/or an electronic controller system which may control a valve or the like. One advantage of that configuration relates to the ability to then selectively use the lives of the two fuel cell stacks. In this manner the fuel cell life and hence the time between maintenance could be doubled, if each are used alternatively to maintain the life of the other. With a minor amendment to the configuration of FIG. 2, such advantages can also be gained from that example arrangement.

This arrangement enables a reduction in reaction area of the fuel cells and/or a reduction in the cell width of the second stack 411. Reduction in the cell area enables preferential integration, reduction in mass of the system 400 as a whole as well as reduction of leakage of reactants (especially H2). Leakage is reduced as the reduced circumference stemming from a reduced cell area, in turn, reduces the length of the needed seals, therefore less likely for leaks to occur. Additionally, over the smaller area, this allows better control over the tolerance of the plates at the seals. In the case of the second fuel cell stack 411 using pure oxygen, there is also no need to evacuate air from the cathode to ensure a constant supply of O2, rather only water needs to be removed. As such, no air outlet is required for normal operation but could be optionally used or included to purge the system 400. An additional advantage is the use of LOX means that the gaseous form oxygen (GO2) could be supplied at a lower temperature reducing the demand on cooling for the fuel cell stacks.

These advantages can also be provided with the arrangement of FIG. 2 shown above and the arrangements of FIGS. 4 and 5 shown below.

Referring to FIG. 5, there is a shown a propulsion system 500. The system 500 shown in FIG. 5 shares a number of elements with the system 400 in FIG. 4. Where the same, or a similar, element is shown in FIG. 5, the numeral from FIG. 4 will be used with the number increased by 100. So, for example, the system 400 of FIG. 4, is similar to the system 500 from FIG. 5. For conciseness, not all elements will be discussed, those that are the same may be omitted from discussion.

As shown in FIG. 4, the system 500 of FIG. 5 has two fuel cell stacks 510, 511. There is a hydrogen portion 502 which provides hydrogen from a hydrogen source 512 to both fuel cell stacks 510, 511. There is a water portion 506 which provides fluid communication for water between the fuel cell stacks 510, 511, a water pump 542, a water tank 540, a heat exchanger 544 and a heat exchanger/condenser 528.

The air portion 504 and the oxygen portion 508 of system 500 differ from the air portion 404 and oxygen portion 408 of system 400. The system 500 of FIG. 5 has an additional compressor 521 when compared to the system 400 of FIG. 4. Compressor B 521 is connected to the oxygen source 514 via fuel cell stack B 511 and is directly connected to the fuel cell stack A 510. Compressor B 521 is therefore part of both the air portion 504 and the oxygen portion 508. The air portion 504 of the system 500 provides air from the air supply 530 to fuel cell stack A 510, but notably in this arrangement not to fuel cell stack B. The oxygen line from fuel cell stack B 511 may be fed directly into one of the existing air lines feeding into fuel cell stack A 510. This reusing of airpath lines reduces the total airpath lines necessary and therefore reduces the mass of the system 500 providing associated benefits of a more lightweight system as mentioned above. A shut-off valve may be used to control passage of the air along the airpath lines, in particular, in the introduction of the oxygen from fuel cell stack B 511 to the airpath lines into fuel cell stack A 510.

The system 500 therefore allows particularly efficient use of the oxygen supplied by the oxygen source 514. When operating the system 500 at high power, oxygen is supplied directly to fuel cell stack B 511, which generates high power output due to the use of oxygen in the fuel cell stack, additionally the unspent oxygen is then communicated to fuel cell stack A 510 to increase the oxygen concentration in the air being supplied to fuel cell stack A 510. In this way, fuel cell stack B 511 provide high power output and the oxygen percentage fed to fuel cell stack A 510 is increase thereby increasing its power output also. Therefore, this is particularly efficient arrangement as the oxygen provided by the oxygen source 514 is (almost) entirely used. The system 500 however only provides air from the air supply 530 to fuel cell stack A 510. As such, the benefit associated with the provision of an exclusively high power fuel cell operating on pure (or higher percentage) oxygen, is provided by the arrangement shown in FIG. 5.

The system 500 shown in FIG. 5 has two compressors 521, 522. However, in alternate arrangements of system 500, the second compressor 522 may not be needed. In the event that compressed O2 is used either originally in a gaseous form or from a liquid form then this compressor will not be needed. Rather that either:
(1) The whole system 500 will be pressurized at either the same or different pressures as required, or
(2) Liquid oxygen will be used and vaporized to the appropriate pressure-this functionality might be provided via a heat exchanger system.

In this case the second fuel cell stack B 511 could be operating at a lower O2 pressure than the first fuel cell stack A 510 (as fuel cell stack A 510 is designed for air) or the first fuel cell stack A 510 operates at a higher pressure to compensate.

The system 500 of FIG. 5 advantageously, and efficiently, makes use of the unspent oxidant from fuel cell stack B 511 in fuel cell stack A 510. Provision of high percentage oxygen (or pure oxygen) increases the oxygen concentration in the air supplied to the fuel cell stack A 510. This therefore increases the specific power of fuel cell stack A 510. A small additional compressor may be required to re-pressurize the un-spent oxygen, this is shown as compressor B 521 in system 500. This arrangement may increase the power provided by the system 500 in comparison to that provided by the system 100 of FIG. 1. As such, for the inclusion of the additional elements, there is still a notable increase in performance provided by the system 500 of FIG. 5, (e.g. for a 1.5 kW/kg base system, approx. 2.9-3.9 kW/kg).

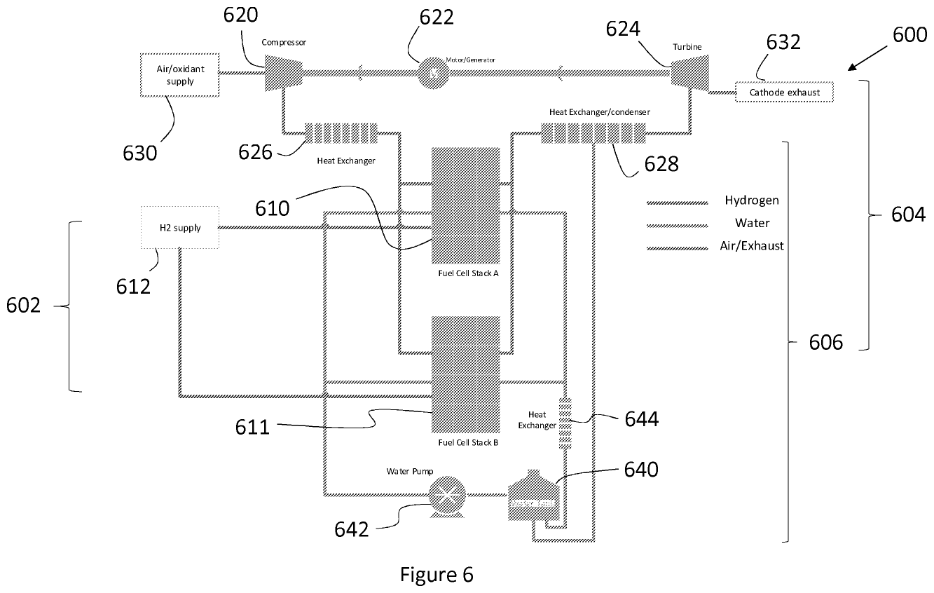

Referring to FIG. 6, there is a shown a propulsion system 600. The system 600 shown in FIG. 6 shares a number of elements with the system 100 in FIG. 1. Where the same, or a similar, element is shown in FIG. 6, the numeral from FIG. 1 will be used with the number increased by 500. So, for example, the system 100 of FIG. 1, is similar to the system 600 from FIG. 6. For conciseness, not all elements will be discussed, those that are the same may be omitted from discussion.

As shown in FIG. 1, the system 600 of FIG. 6 has a fuel cell stack A 610. There is a hydrogen portion 602 which provides hydrogen from a hydrogen source 612 to fuel cell stack A 610. There is a water portion 606 which provides fluid communication for water between the fuel cell stack A 610, a water pump 642, a water tank 640, a heat exchanger 644 and a heat exchanger/condenser 628.

Unlike the system 100 shown in FIG. 1, the system 600 of FIG. 6 also has a second fuel cell stack B 611. The hydrogen portion 602 also provides hydrogen to the second fuel cell stack 611 and the water portion 606 also provides fluid communication for water between the first fuel cell stack 610, the second fuel cell stack 611, the water pump 642, the water tank 640, the heat exchanger 644 and the heat exchanger/condenser 628.

The system 600 of FIG. 6 also has an air/exhaust portion 604 which allows delivery of air or oxygen from an air/oxidant supply 630 to both fuel cell stacks 610, 611. The system 600 has no additional compressor, as for the system 500 shown in FIG. 5.

System 600 uses an additional fuel cell stack 611 to provide an additional power when desired (in comparison to the arrangement of FIG. 1). In an example, this may be during takeoff and climb of an aircraft when additional power is required. Oxidant may be supplied to fuel cell stack B 611 by operating the balance of plant in an over rated condition (10 to 25%, while more is desirable it may not be feasible in terms of longevity of the fuel cell) for the short duration required for take-off and climb. When overrating a fuel cell, the pressure of air entering the fuel cell is increased. Advantageously, this increases the amount of oxygen entering the fuel cell. This therefore increases the power output of the fuel cell however this process also degrades (at a greater rate than during normal usage conditions) the membranes on the bipolar plates which may reduce the lifetime of the fuel cell. In an example, the over rated condition may be a use of around 10% to 25% over rating.

When used in such a manner, the system 600 can provide a power output increase of around leading to a maximum achievable of 2 to 2.46 kW/kg for a 1.5 kW/kg base system. In particular, with this arrangement 600, it is possible to reduce losses due to pumps and heat exchangers as the fuel cell stack number has been doubled (compared to FIG. 1) but the pumps and heat exchangers have not been doubled in full (compared to FIG. 1). As such, there is a greater power available per weight in the arrangement of FIG. 6 over the arrangement in FIG. 1.

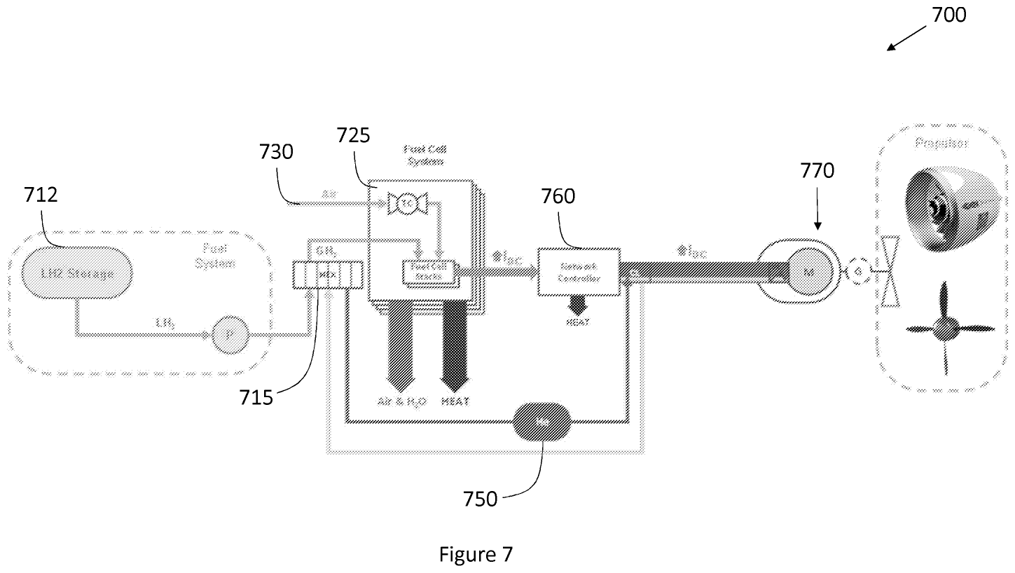

Referring to FIG. 7, there is a shown a propulsion system 700. The propulsion system 700 has a fuel cell system 725 comprising features as shown in previous figures, such as fuel cell stacks. An air supply 730 feeds to fuel cell system 725. Liquid hydrogen supply 712 provides liquid hydrogen to a heat exchanger 715. At the heat exchanger 715, the liquid hydrogen interacts with a helium supply 750. The liquid hydrogen exits the heat exchanger 715 as gaseous hydrogen and enters the fuel cell system 725.

The fuel cell system 725 provides electrical energy in the form of a direct current. The fuel cell system 725 also provides air and water as well as thermal energy in the form of heat. The electrical energy from the fuel cell system 725 is provided into a network controller 760. The current is then provided to a motor and generator arrangement 770 to provide kinetic energy from the electrical energy to a propulsor for providing motion.

The helium in the helium loop is cooled by the liquid hydrogen in the heat exchanger 715. The cooled helium can then provide cooling on direct items such as the electrical connection providing the electrical energy from the network controller to the motor and generator arrangement 770, and the motor and generator arrangement 770 itself. Helium is advantageous in such a system as it has a lower melting point than hydrogen and therefore can be cooled by hydrogen without danger of freezing in the conduits holding the helium. Other cryo coolants may be used, however helium is particularly advantageous.

There are a number of advantages that are provided by the fuel cell propulsion systems as disclosed herein. In the arrangements that utilise liquid oxygen (e.g. at least in examples of the systems shown in FIGS. 2, 3 and 4), the heat capacity and specific heat of vaporization of the oxygen can be used to dissipate thermal loads during high power operation (either of both the fuel cell stacks or specifically of the high power fuel cell stack).

In all the systems disclosed herein, the required air intake for the system as a whole is reduced in comparison to modern systems. This, in turn, reduces the drag penalty associated with larger air intake requirements (this is mirrored across the propulsive power and energy required from the system with said intake). In the instances wherein the system uses pure oxygen, as in FIGS. 2 to 4, the size of the intake is minimized to being required for only fuel cell stack A in cruise. Alternatively, the intake may be designed to support all flight condition. One consequence could be that the intake is stowed/closed except when stack A is operating with air in cruise. In this way, again, drag improvements over modern systems can be achieved for the systems as disclosed herein.

An advantage of these approaches is that the advantages provided by these systems are by virtue of the arrangement and components in the systems themselves. These arrangements and components are self-contained and therefore the advantages do not negatively impact other areas of the wider system in which the fuel cell propulsion systems are used. In particular, these arrangements are independent of performance improvements in the state of the art. The performance of the systems disclosed herein provides a factored improvement on the capabilities of the fuel cell stacks and conventional balance of plant components. If, in the future, the performance of state of the art fuel cells is increased, then the improvements disclosed herein still follow in a similar ratio.

The systems disclosed herein have clear advantages associated with them in terms of providing propulsion. The systems also overcome biases which are present in current state of the art. In particular, the systems disclosed herein reverse a common approach of expending oxygen rather than hydrogen for range rather than power. This approach is logically applicable to utilization of the fuel cell as a range extender but notably not as the primary power source. In that case, the reverse approach is more appropriate due to the energy used and mass/volume of hydrogen.

Systems disclosed herein may advantageously utilize the ECS outflow air which is already pressurized to reduce the compression need of the fuel cell turbo-compressor (or compressor). This air can be oxygen enriched (due to the usage of oxygen filters-as described above) and/or to further oxygen separate the air before compression to reduce energy consumed. Furthermore, in modern aircraft there is a trend of increasing the oxygen content of cabin air, and also increasing air changes (the number of times the cabin air is theoretically completely refreshed), and these factors both offer benefits which are taken advantage of in the presently disclosed systems. In particular, the number of air changes has been increasing over time with an average now of around 15; older aircraft maybe having 8 air changes while modern aircraft may have 20 or more changes.

The use of enriched oxygen may reduce the power demand upon the system as a whole. In a possible arrangement, LOx enables pressurized GO2 to be supplied into the fuel cell stacks with minimal balance of plant demands. The oxygen is consumed and therefore the integration mass of the system is not significantly increased. This approach reduces the dependency upon the stack and the state of the art balance of plant performance.

Although the fuel cell propulsion systems disclosed have mostly been described in terms of aircraft, other vehicles such as spacecraft and submarines or the like may carry oxygen or liquid oxygen. Although, this oxygen or liquid oxygen may be carried primarily for other reasons, integration of additional oxygen for use in the fuel cells of the presently disclosed systems would not be mechanically intensive. Alternatively, or additionally, these vehicles might advantageously be arranged to provide excess oxygen or liquid oxygen to a fuel cell propulsion system as described herein. As such, the disclosed systems would be advantageously provided in such vehicles. Any vehicle which might be propelled by a fuel cell propulsion system such as that described herein would benefit from use of the systems disclosed herein.

The system disclosed herein might be advantageously used to provide propulsion in a vehicle or system which may benefit from a system that can provide a controllably variable amount of propulsion across a wide range of propulsion values.

Numerous advantages are provided by a production of power from fuel cells rather than say via combustion engines. The production of water in place of harmful gaseous emissions (NOx, CO2 etc) has clear associated advantages. Furthermore, operation of the vehicle can occur with significantly reduced noise levels. In a particular example, takeoff and landing phases for aircraft can occur with significantly reduced noise levels due to the lack of high velocity exhaust gas.

Provision of additional selectable thrust (by converting the fuel cell electrical power provided by the system described herein into thrust via an electric motor or the like) can also be used by the operator of the vehicle whenever desired. This flexibility would enable a pilot to optimise the thrust choice for the stage of flight or motion (e.g. a race car along a straight). These systems may also not restrict an operator to a particular fuel cell stack if, for example, a change in thrust is desired at any stage in a flight to overcome, or adapt to, changes in flight conditions.

Applications for this system therefore may include automotive, space, domestic or commercial and so forth.

A further benefit of the use of fuel cells over combustion engines as disclosed herein is that microbe colony formation which occurs in existing aircraft kerosene fuel tanks is avoided. The cleaning of such tanks currently requires detergent insecticide cleaners that are somewhat environmentally damaging. In some cases this cleaning may be after each long haul flight. Therefore, the reduction in cleaning has further environmental benefits.

1. A power unit suitable for use in an aircraft, the power unit comprising:
at least one fuel cell; and
at least two fuel sources for providing fuel to the at least one fuel cell;
wherein a first fuel source is a hydrogen supply arranged to provide hydrogen to a first fuel cell of the at least one fuel cell, and
wherein a second fuel source is an air gas supply arranged to provide air gas to a first fuel cell of the at least one fuel cell.

2. The power unit of claim 1, wherein the at least one fuel cell comprises a first fuel cell and a second fuel cell, and
wherein a third fuel source is an oxygen supply arranged to provide oxygen to the second fuel cell.

3. The power unit of claim 2, wherein the hydrogen supply is further arranged to provide hydrogen to the second fuel cell.

4. The power unit of claim 2, wherein the air gas supply is further arranged to provide fluid communication for the air gas between the air gas supply and the second fuel cell.

5. The power unit of claim 2, wherein the oxygen supply is further arranged to provide oxygen to the first fuel cell.

6. The power unit of claim 2, wherein the power unit further comprises:
at least one compressor for compressing a fuel source of the at least two fuel sources,
wherein a first compressor of the at least one compressor and the fuel source of the at least two fuel sources are arranged so that the fuel from the fuel source is communicated to the at least one compressor prior to being provided to a fuel cell of the at least one fuel cell.

7. The power unit of claim 6, wherein the oxygen supply is arranged in fluid communication with a second compressor of the at least one compressor, the oxygen supply arranged to:
provide oxygen to the second fuel cell;
provide oxygen to the second compressor; and,
provide oxygen to the first fuel cell.

8. The power unit of claim 7, wherein the oxygen supply is arranged to provide uncompressed oxygen to the second fuel cell and compressed oxygen to the first fuel cell.

9. The power unit of claim 2, further comprising a control unit to control supply of fuel from the at least two fuel sources to the at least one fuel cell,
wherein the second fuel cell can be selectively activated by selectively providing fuel to the second fuel cell.

10. The power unit of claim 2, wherein the first fuel cell and second fuel cell are arranged to use a common balance of plant.

11. The power unit of claim 2, further comprising a liquid heat exchanger arrangement for exchanging heat with the at least one fuel cell,
the liquid heat exchanger comprising a fluid arranged at least at one point in the liquid heat exchanger arrangement in thermal communication with the at least one fuel cell, and
a cryogenic heat exchanger arrangement arranged at least at one point in thermal communication with the fluid.

12. The power unit of claim 11, wherein the third fuel source is a liquid oxygen supply and the third fuel source is arranged to provide oxygen to the cryogenic heat exchanger arrangement.

13. The power unit of claim 12, wherein the third fuel source is arranged to:
provide liquid oxygen to the cryogenic heat exchanger arrangement to cool the fluid, and
provide gaseous oxygen from the cryogenic heat exchanger arrangement to the at least one fuel cell.

14. The power unit of claim 13, wherein the liquid heat exchanger arrangement comprises a fluid conduit through which fluid can flow and a liquid heat exchanger and wherein the cryogenic heat exchanger arrangement comprises a cryogen conduit through which cryogen can flow and a cryogenic heat exchanger.

15. The power unit of claim 1, wherein the air gas supply is environmental control system exhaust gas or ambient air.

16. The power unit of claim 1, wherein the hydrogen supply is a hydrogen gas supply to provide hydrogen gas arranged to provide hydrogen gas to a first fuel cell of the at least one fuel cell.

17. A power unit comprising:
at least two fuel cells;
at least two fuel sources for providing fuel to the at least two fuel cells;
wherein a first fuel source is a hydrogen gas supply arranged to provide hydrogen gas to each of the two fuel cells; and
wherein a second fuel source is an air gas supply arranged to provide air gas to each of the two fuel cells.

18. An aircraft propulsion system comprising the power unit of claim 1.

19. A method of providing variable power for use in an aircraft, the method comprising:
providing a first fuel from a first fuel source to a first fuel cell, wherein the first fuel source is a hydrogen gas supply to provide hydrogen gas to the first fuel cell;
providing a second fuel from a second fuel source to a first fuel cell, wherein the second fuel source is an air gas supply to provide air gas to the first fuel cell;
activating the first fuel cell to provide power using the hydrogen gas and the air gas;
providing hydrogen gas from the hydrogen supply to a second fuel cell;
providing a third fuel from a third fuel source to the second fuel cell, wherein the third fuel source is an oxygen supply to provide oxygen to the second fuel cell; and
selectively activating the second fuel cell to provide additional power.

20. The method of claim 19, wherein the second fuel cell is selectively activated during takeoff and climb phases of an aircraft flight.

21. An aircraft propulsion system comprising the power unit of claims 17.
